(19) United States
(12) Patent Application Publication
(10) Pub. No.: US 2022/0340192 A1
(43) Pub. Date: Oct. 27, 2022

(54) FABRIC-SUPPORTED WIRING

(71) Applicant: Autoliv Development AB, Vargarda (SE)

(72) Inventor: Jeremie POINT, Cherves (FR)

(21) Appl. No.: 17/754,294

(22) PCT Filed: Sep. 30, 2020
(86) PCT No.: PCT/EP2020/077291

§ 371 Date: Mar. 29, 2022

(30) Foreign Application Priority Data
Oct. 3, 2019 (FR) FR1910971

(51) Int. Cl. B62D 1/06

(52) U.S. Cl. CPC B62D 1/065

(57) ABSTRACT

A composite sheath for a vehicle steering wheel, the steering wheel comprising a rim and at least one first electrical device, such as a switch or light strip, the composite sheath being arranged to cover the rim at least partially, the composite sheath comprising at least one second electrical device, such as a resistive heating wire or a metal weft for a capacitive sensor, characterized in that wherein the composite sheath further comprises an electrical conductor arranged so as to be connected to the at least one first electrical device.

### TECHNICAL FIELD

The present invention relates generally to the field of vehicle steering wheels, and more particularly the wiring thereof.

As the functionalities offered to drivers or users of motor vehicles (cars, including self-driving cars, trucks and generally any type of vehicle) are being developed, the manufacture of steering wheels has become more complex and more expensive. In addition, while multiplying the functions available to the user, it is expedient to optimize the ergonomics and wiring of the various constituent elements.

### PRIOR ART

The prior art document EP1046565 discloses a steering wheel comprising electrical control devices on the rim and spokes of the steering wheel.

The abovementioned steering wheel of the prior art has the particular disadvantage of not enabling the compact wiring of the steering wheel or the positioning of electrical elements over a broad perimeter of the steering wheel. Furthermore, there is no provision for the possibility of having electrical elements of different natures, or of facilitating wiring at the time of manufacture.

### SUMMARY OF THE INVENTION

With this goal in mind, and in a first aspect, the present invention relates to a composite sheath for a vehicle steering wheel,

the steering wheel comprising a rim and at least one first electrical device, such as a switch or light strip,

the composite sheath being arranged to sheathe the rim,

the composite sheath comprising at least one second electrical device, such as a resistive heating wire or a metal weft for a capacitive sensor, characterized in that

the composite sheath further comprises an electrical conductor arranged so as to be connected to the at least one first electrical device which is distinct from the second electrical device.

The composite sheath is arranged to cover the rim at least partially.

In other words, the present invention relates to a composite sheath arranged to sheathe a vehicle steering wheel, the composite sheath comprising at least one second electrical device, such as a resistive heating wire or an electrical weft for a capacitive sensor, and at least one electrical conductor arranged so as to be connected to at least one first electrical device of the steering wheel, such as a switch or light strip, and being distinct from the second electrical device.

This makes it possible to propose a composite sheath for a vehicle steering wheel which facilitates assembly or manufacture, in particular by saving on wiring steps, to improve the service life with more robust, and simpler, wiring, and which enables easy wiring over a large portion of the steering wheel with a compact wiring arrangement. This further makes it possible particularly to propose electrical devices of identical or different nature on the steering wheel.

In particular, it should be noted regarding the above implementation that the first electrical device is part of the vehicle steering wheel, which also comprises the composite sheath. In other words, the first electrical device is distinct from the composite sheath, since it is not part of the latter. However, the composite sheath houses a wiring element which is dedicated to the connection of the first electrical device, which limits the number of components to be assembled.

Advantageously, the first electrical device can be independent of the second electrical device.

This makes it possible to propose a composite sheath for a steering wheel with a large panel of electrical functionalities, without hampering the operation of one relative to another, enabling a compact arrangement and facilitating wiring for manufacture and maintenance.

Advantageously, the second electrical device can comprise the electrical conductor.

This makes it possible to facilitate the manufacture and assembly of the composite sheath and of the steering wheel, particularly by saving on an assembly step by the shared assembly of the second electrical device and the electrical conductor.

Advantageously, the first or the second electrical device may have a functionality for the driver or the user.

Advantageously, the first or the second electrical device may comprise a user interface.

In other words, the first or the second electrical device are not only electrical conductors, but are electrical devices provided with a functionality and with a human-machine interface for the driver or the user.

Advantageously, the electrical conductor can be an electrical wire or a cable harness.

Advantageously, the electrical conductor can be composed of a plurality of wires, preferably sheathed.

Advantageously, the electrical conductor can be a cable or an electrical ribbon cable.

This makes it possible to propose a composite sheath for a steering wheel having easy and robust wiring, facilitating production and increasing the service life.

Preferably, the electrical conductor can be adhesively bonded, sewn, embedded or printed in or on the composite sheath.

This makes it possible to propose a composite sheath for a steering wheel having easy and robust wiring, facilitating production and increasing the service life. Furthermore, this improves the protection of the electrical conductor and this makes it possible to use an additive manufacturing method.

In one embodiment, the electrical conductor can comprise at least one connector.

In a particular embodiment, the at least one connector can be arranged at at least one end of the electrical conductor.

Advantageously, the steering wheel can comprise two first electrical devices, and the electrical conductor is divided into two portions, each portion being connected to one of the two first electrical devices.

This makes it possible to propose a composite sheath for a steering wheel which facilitates the connection of the electrical devices and the wiring, particularly in the case of first electrical devices arranged on either side of the steering wheel.

A second aspect of the present invention relates to a vehicle steering wheel comprising a rim and a composite sheath according to the first aspect, the composite sheath being arranged to cover the rim at least partially.

This makes it possible to propose a steering wheel with a composite sheet having easier manufacture, easy and robust wiring, a high degree of compactness, a better service life and a large range of functionalities offered to the driver.

A third aspect of the present invention relates to a vehicle comprising a steering wheel according to the preceding aspect.

This makes it possible to propose a vehicle with a steering wheel offering broad functionalities to the driver, while proposing a compact arrangement, an excellent service life and a high degree of robustness, with easy and simplified manufacture.

### BRIEF DESCRIPTION OF THE FIGS.

Other characteristics and advantages of the present invention will become more clearly apparent upon reading the following detailed description presenting different embodiments of the invention, provided by way of example but in no way limited thereto, and illustrated by the attached drawings, in which:

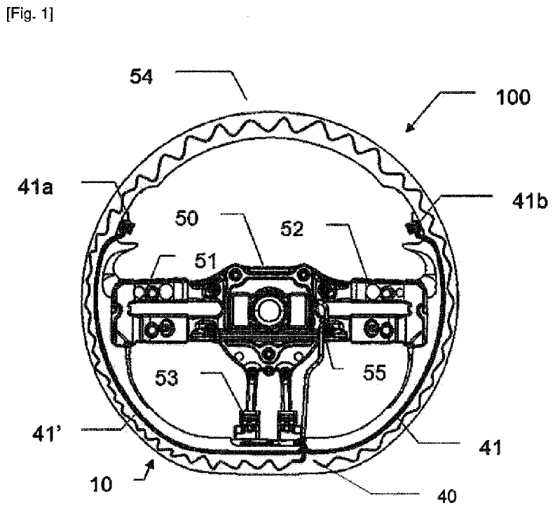

FIG. 1 depicts an embodiment of a vehicle steering wheel comprising an uncovered composite sheath in front view and a steering wheel rim according to a first embodiment;

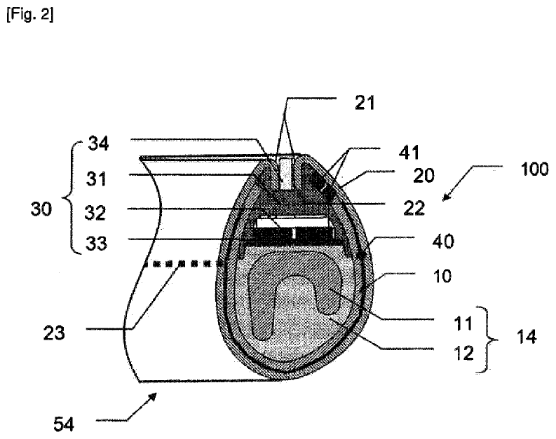

FIG. 2 depicts a sectional view of the composite sheath and of the rim according to a second embodiment.

### DETAILED DESCRIPTION

FIG. 1 depicts an embodiment of a vehicle steering wheel comprising an uncovered composite sheath in front view according to a first embodiment.

The steering wheel 100 is depicted in front view, i.e. as seen by the driver of the vehicle.

The steering wheel 100 comprises a central hub 50, three spokes (herein double spokes) 51, 52, 53, and a rim 54. The spokes 51, 52, 53 connect the central hub 50 to the rim 54. The steering wheel 100 further comprises a composite sheath 10.

The composite sheath 10 is arranged to cover the rim 54 at least partially, and comprises a first electrical conductor 41 having, at one end thereof, a connector 41 b and also a second electrical conductor 41′ having, at one end thereof, a connector 41a. The connectors 41a and 41b are arranged to be connected to a control device such as a switch, for example housed on a spoke of the steering wheel. The other ends of the conductors 41 and 41′ are arranged to be connected to another part of the first electrical device 30. The connectors 41a and 41b can be connected to different types of first electrical devices 30, such as electrodes or light devices (depicted in FIG. 2) or switches (not shown) in this embodiment, which are therefore distinct from the composite sheath.

FIG. 2 depicts a sectional view of the rim 54 of the steering wheel 100, comprising the composite sheath 10 according to a second embodiment.

The rim 54 of the steering wheel 100 comprises an armature 11 (produced from metal such as aluminum or magnesium), and an overmolding material 12 (polyurethane for example, and also referred to as foam or foam material), overmolded around the armature 11 to form a support 14.

The composite sheath 10 is covered with an outer sheath 20 (typically made of natural or artificial leather, but other materials are possible), the ends of which are connected by adhesive bonding and optionally by an edge-to-edge seam 23.

The steering wheel 100 comprises a first electrical device 30, such as a light strip or an electrode for measuring a vital sign of the driver, passing at least partially through the outer sheath 20, to serve as an interface with the driver and/or to send light signals, for example.

Indeed, the first electrical device 30 comprises an electronic circuit (a printed circuit 32 attached to the support 14, housing light sources (light-emitting diodes, for example), a lower attachment interface 33, an upper attachment interface 31 (which can be transparent or locally pierced to allow light to pass), and a light guide 34 to be able to illuminate a part of the steering wheel, so as to improve the ergonomics of the human-machine interface of the vehicle.

It is therefore necessary to pass through the outer sheath 20 to send light signals to the driver from elements arranged on the support 14 and under the outer sheath 20. However, the outer sheath 20 is typically produced from a strip of material (or several strips of material) which, during assembly, have to sheathe the rim. The upper attachment interface 31 comprises a groove 22 arranged to receive the light guide 34 and flaps or folded edges 21 of the outer sheath 20, folded toward the inside of the rim 54 and adjacent to the edges of the light guide 34.

The composite sheath 10 further comprises a second electrical element 40 such as a heating ribbon or a proximity sensor additionally to the electrical conductor 41 arranged to be connected to the first electrical device 30. It should be noted that the first electrical device 30 in this figure is arranged more toward the center of the rim and is therefore separated from the composite sheath 10 arranged at the periphery of the rim, under the outer sheath 20. In other words, the first electrical device 30 is distinct from the composite sheath 10.

The electrical conductor 41 is preferably a wire or a plurality of electrical wires, an electrical ribbon cable or else an electrical cable. The electrical conductor 41 can be printed in or on the composite sheath 10, or adhesively bonded, sewn or embedded. This makes it possible particularly to increase the service life of the components by good strength and simplifying the design of the composite sheath 10 and of the steering wheel 100.

In a particularly advantageous embodiment, the electrical conductor 41 can be formed with the second electrical device 40. Thus, for example, when the second electrical device 41 is a heating ribbon which may cover a large portion of the rim 54, the electrical conductor 41 may be a wire or a printed circuit contained within the heating ribbon, in addition to the resistive wires (or metal weft) of the heating ribbon, which makes it possible to directly assemble the electrical conductor 41 with the heating ribbon.

The electrical conductor 41 comprises two connectors 41a, 41b, depicted in FIG. 1. The steering wheel 100 can comprise two first electrical devices 30 connected to the two connectors 41a, 41b positioned at the ends of two portions of the electrical conductor 41.

It will be understood that various modifications and/or improvements which are obvious for the person skilled in the art may be made to the different embodiments of the invention described in the present description, without departing from the scope of the invention.

In particular, reference is made to the first electrical device 30 having a light guide 34 arranged at the surface of the steering wheel rim, and passing through the outer sheath 20, but it is possible to envisage providing, as first electrical device 30, a control interface, a position sensor, a biometric sensor element, buttons which pass through the outer sheath 20.

The outer sheath 20 can be produced from several strips of the same material or of different materials (leather, synthetic, fabrics, etc.).

The first electrical device 30 can also be one or more light-emitting diodes, a liquid crystal or plasma screen, an electro-acoustic device, a photographic or video device, or else a device for finger or visual recognition.

Finally, the through-opening or groove 22 for the light guide 34 (or light device) can be facing the driver in order to display light information, but it is also possible to make the opening on a side of the rim opposite the driver, in order to pass a sensor therethrough for detecting the driver's fingers, for example.

1. (canceled)

10. A composite sheath for a vehicle steering wheel,
the steering wheel comprising a rim and at least one first electrical device, such as a switch or light strip,
the composite sheath being arranged to sheathe the rim,
the composite sheath comprising at least one second electrical device, such as a resistive heating wire or a metal weft for a capacitive sensor,
wherein
the composite sheath further comprises an electrical conductor arranged so as to be connected to the at least one first electrical device which is distinct from the second electrical device.

11. The composite sheath according to claim 10, wherein the electrical conductor is a cable or an electrical ribbon cable.

12. The composite sheath according to claim 10, wherein the electrical conductor is composed of a plurality of wires.

13. The composite sheath according to claim 10, wherein the electrical conductor is adhesively bonded, sewn, embedded or printed in or on the composite sheath.

14. The composite sheath according to claim 10, wherein the electrical conductor comprises at least one connector.

15. The composite sheath according to claim 14, wherein the at least one connector is arranged at at least one end of the electrical conductor.

16. The composite sheath according to claim 10,
the steering wheel comprising two first electrical devices, and
wherein the electrical conductor is divided into two portions, each portion being connected to one of the two first electrical devices.

17. A vehicle steering wheel comprising a rim and a composite sheath according to claim 10, the composite sheath being arranged to cover the rim at least partially.

18. A vehicle comprising a steering wheel according to the preceding claim 17.
